(19) United States
(12) Patent Application Publication
(10) Pub. No.: US 2007/0222096 A1
(43) Pub. Date: Sep. 27, 2007

(54) Apparatus and Method for Manufacturing Pre-Formatted Linear Optical Data Storage Medium

(76) Inventor: W. Dennis Slafer, Arlington, MA (US)

Correspondence Address: MCDERMOTT WILL & EMERY LLP, 28 STATE STREET, BOSTON, MA, 02109-1775, US

(21) Appl. No.: 10/588,098

(22) PCT Filed: Jan. 21, 2005
(86) PCT No.: PCT/US05/01856

§ 371 Date: Dec. 18, 2006

Related U.S. Application Data
(60) Provisional application No. 60/537,847, filed on Jan. 21, 2004.
(60) Provisional application No. 60/538,120, filed on Jan. 21, 2004.

(51) Int. Cl. B29C 51/22

(52) U.S. Cl. 264/2.1; 425/175

(57) ABSTRACT

An apparatus for manufacturing pre-formatted linear optical data storage media including an elongated linear polymer layer. The apparatus includes a drum mounted for rotation about a rotation axis, and the drum includes a circumferential outer surface having a predetermined pattern of protrusions for embossing at least one pattern of optically readable embossments in the elongated linear polymer layer as the layer is rolled on the drum. The apparatus also includes a thermal radiation source positioned adjacent the drum for heating the embossments of the elongated linear polymer layer prior to the layer being removed from the protrusions of the outer surface of the drum.

### CROSS-REFERENCE TO RELATED APPLICATIONS

The present application claims priority to co-pending provisional U.S. patent application Ser. No. 60/537,847 (Atty. Docket No. MCMK-3A-PR), which was filed on Jan. 21, 2004, is assigned to the assignee of the present application, and is incorporated herein by reference.

The present application also claims priority to co-pending provisional U.S. patent application Ser. No. 60/538,120 (Atty. Docket No. MCMK-4A-PR), which was filed on Jan. 21, 2004, is assigned to the assignee of the present application, and is incorporated herein by reference.

### FIELD OF THE DISCLOSURE

The present disclosure relates generally to computer data storage and, more particularly, removable media for storing computer data. Even more particularly, the present disclosure relates to pre-formatted linear optical data storage media, and an apparatus and method for manufacturing pre-formatted linear optical data storage media.

### BACKGROUND OF THE DISCLOSURE

In the field of optical and magneto-optical computer information storage systems, it has long been recognized that incorporating physical features into the surface of a storage element, such as a disc or card (hereafter referred to as “media” or “medium”), provides a number of advantages for data storage media. Precise position and tracking, error correction, focusing, and other information can be provided or enhanced by these surface features, and this information is used by the hardware and control system with which the storage element is designed to operate (hereafter referred to as “drive” or “transport”). These surface features are “read” by means of an optical pickup device (hereafter referred to as “optical head” or “optical pickup unit”) that is a key component of the drive. Media surface features typically include pits, lands, grooves, and the like. For the majority of optical storage media, the surface features are incorporated into the media (e.g., the disc substrate) at the time of manufacture, and this process is generally referred to as physical pre-formatting (herein “pre-formatting”).

In the case of recordable and erasable compact discs (“CD”), digital versatile discs (“DVD”), magneto-optical discs (“MO”), and other media, such pre-formatting is accomplished by means of a molding process, whereby a molten polymer (substrate) material is brought into contacted with a patterning surface (“tool”) whose surface contains the mirror-image of a surface relief structure that is to be imparted to the disc surface. For example, U.S. Pat. No. 4,428,069 shows one such method for pre-formatting discs. After sufficient cooling has occurred, the disc is removed from the molding machine, and various layers are applied over this surface relief structure, such as reflective layers, recordable layers, protective layers and the like.

A CD typically has a single spiral track of data, circling from the inside of the disc to the outside of the disc. The spiral track has very fine surface modulations (often in the form of pits, bumps, or grooves) containing features with dimensions in the submicron size range. When a CD is played, a laser beam passes through the CD's polycarbonate substrate layer, reflects off a reflective layer to an optoelectronic device that detects changes in light. The difference in height of the pits, bumps, and grooves relative to the flat parts of the substrate surface results in a change, or modulation, of the reflected light. An optoelectronic sensor in the head detects these changes in reflectivity, and the electronics in the CD-player (drive) interpret the changes as data bits. For pre-recorded information (music, software, etc.), these pits are used to store the data, as well as provide positional information. For recordable or erasable discs, the pre-formatted structures are typically used for positioning, tracking, and writing/erasing user data.

In the present art, a durable tool, often referred to as a “stamper”, is used to impart the pattern into the substrate surface and is typically made from a “master” pattern by a metal electroforming or electroless plating process. The master pattern, in turn, is made on a laser beam recorder, a device in which a recording medium, consisting of a photosensitive layer coated on a substrate is rotated on a lathe or spindle and exposed to a modulated laser beam. Chemical development of the exposed pattern results in a surface relief pattern that will ultimately be replicated into the optical disc substrate, as previously described. Although a number of variants exist, such steps as these are typical of the basic manufacturing process of optical discs.

The performance and tolerance requirements of the laser beam recorder systems that create the master patterns are very high and, therefore, the process requires very expensive hardware and optical components, and the laser beam recorder systems must be housed in a clean-room environment. The molding process used to make the polymer substrates mechanically reproduces the master pattern. It should be noted that the relief structures that are molded into the surface of optical storage media are very precise copies of the same features that the laser beam recorder laser inscribes into the master substrate.

The manufacturing process described above dominates the optical disc manufacturing industry and is designed to enable very low-cost media and hardware production. Low-cost production is achieved by placing the requirements for high precision and accuracy in the master pattern step, which is done relatively infrequently. Precision molding is used to make the plastic replicas rapidly and inexpensively and with nearly the same level of precision and accuracy as the original master pattern, as noted above. This approach has enabled the production of low cost discs in high volumes, and for this reason, the process of pre-molding the surface features, for both pre-recorded and recordable/erasable optical discs, has completely replaced early variants in which formatting was incorporated either after the disc was manufactured or “in the field”.

The accuracy, precision, and small feature size that can be achieved in a laser beam recorder mastering facility is greater than can be achieved by carrying out this operation in the field, since the relatively inexpensive drives used by industrial an/or consumer optical disc systems do not have the same level of precision as the laser beam recorders used to create the master pattern. The higher information density (i.e., closer and smaller features) achievable by a laser beam recorder, relative to an inexpensive drive, allows more information to be stored on a disc, so thus pre-formatted optical discs optical head designs. These optical tape systems use a variety of read/write technologies, including vertical cavity surface-emitting lasers (“VCSEL”) based arrays, magnetically levitated spinning polygons, and multiplexed high-power lasers with custom semiconductor channel modulators. These systems are all based on expensive and/or complex optical head architectures, which considerably increase the cost and development time for such systems. Additional drawbacks to these systems include one or more of the following: the inability of fixed position multiple beam heads to deal with large track pitch variations (e.g., resulting from dimensional changes in the tape substrate), the potential cost and difficulty of replacing one or more head elements when it malfunctions or fails, the difficulty and precision required to align individual head elements in a multi-beam system, especially in the field.

There have been various proposals for dealing with some individual aspects of these problems (such as those disclosed in U.S. Pat. Nos. 5,239,528, 5,120,136, and 4,633,455). For example, an optical tape drive “including redundant optical heads to continue reading and writing data to an optical tape in the event of failure of one or more optical heads” is disclosed in U.S. Pat. No. 6,058,092. But no proposed solution or previous art addresses an integrated system, including the media and the head, that solves all of the problems and disadvantages of the prior art.

A number of attempts have been made to apply preformatted features to magnetic tape media in order to improve its areal density and performance. Earlier attempts include the use of magnetic heads to write simple tracks and the like, in which the resolution and accuracy is limited in these examples due to the limited resolution of the magnetic heads themselves, and these format features are susceptible to accidental erasure as well. Later attempts include the use of lasers to etch guide tracks on the tape (such as those disclosed in U.S. Pat. Nos. 6,433,951 and 6,480,351). These processes, however, also suffer from significant limitations, including a format resolution limited by the wavelength, precision, and accuracy of the writing laser, which is usually much coarser than very short wavelength lasers used in the disc pre-formatting process. Thus the areal density of even such “servo-guided” tapes is significantly below that of optical discs.

U.S. Pat. No. 5,045,676 discloses a card medium that might also be manufactured as a tape, and describes optical patterns consisting of discrete interlocking rings disposed along the length of the card medium. This method, however, has a number of disadvantages and limitations, including very inefficient use of surface area, since only the area containing the ring pattern is useable, with much area wasted. Furthermore, the possible use of this medium in a tape cartridge configuration, as suggested in the invention, requires that the entire cartridge to be spun at high rotation rates about an axis going through the hypothetical center of a given disc pattern. This is a very complex, costly, and impractical procedure insofar as the difficulties involved in rotating a rather large, unbalanced mass particularly with different amounts of tape are on either spool) precisely about a virtual center while maintaining acceptable runout, balance and tensioning. Alternatively, using a spinning optical head or mirror arrangement, etc., at high rotation rates would likewise be impractical for a number of reasons. These critical issues are neither discussed nor taught by the patent.

Other prior art includes methods for duplicating magnetic tape (e.g., U.S. Pat. No. 4,882,637), which is useful only for replicating magnetic bits with the same resolution limitation as the magnetic tape from which it is copied and which does not create features that can be easily read by means of optical head.

U.S. Pat. No. 5,872,758 describes a read-only tape that is formed from a pattern spiral-wrapped around a cylinder. This media, however, is neither recordable nor capable of extended tape lengths due to the limited amount of tape that can be spiral wrapped around the cylinder. For example, to make a tape 1,000 meters long in standard ½-inch width would require a 3-foot wide drum that is 13 ft in diameter, which would be prohibitively expensive. Further, this tape requires slitting in a diagonal fashion by an extremely complex slitting means which is not fully taught by the invention.

What is still desired is a new and improved optical tape system that provides the benefits of practical, low-cost pre-formatted optical disc media used with commercially available optical heads, and provides high areal density and a longer operational lifetime. The new and improved optical tape system will also include pre-embossed guide and information-bearing structures that provide the beneficial aspects of a linear media with a large storage surface area. What is also desired is a new and improved method for manufacturing optical tape having pre-embossed information-bearing structures.

### SUMMARY OF THE DISCLOSURE

Exemplary embodiments of the present disclosure provide an optical information storage system that includes a linear optical data storage media having pre-embossed information-bearing structures, and at least one optical disc-type head for reading recording marks in the pre-embossed information-bearing structures of the linear optical data storage media. The present disclosure also provides an apparatus and method for manufacturing linear optical data storage media having pre-embossed guide and information-bearing structures.

According to one aspect of the present disclosure, there is provided an apparatus for manufacturing pre-formatted linear optical data storage media including an elongated linear polymer layer. The apparatus includes a drum mounted for rotation about a rotation axis, and the drum includes a circumferential outer surface having a predetermined pattern of protrusions for embossing at least one pattern of optically readable embossments in the elongated linear polymer layer as the layer is rolled on the drum, and wherein the pattern of optically readable embossments has features readable by DVD-type optical heads. The apparatus also includes a thermal radiation source positioned adjacent the drum for heating the pattern of optically readable embossments of the elongated linear polymer layer prior to the layer being removed from the protrusions of the outer surface of the drum.

A system constructed and operated in accordance with aspects of the present disclosure enables significant improvements relative to existing storage systems in terms of areal density, storage capacity, performance, and cost. The improved performance of the system described herein includes, but is not limited to, high storage capacity, improved media-drive interchange characteristics, fast data access times, high read/write rates, and archival media. Of particular significance is the benefit of a total storage capacity that is significantly greater than any optical disc or magnetic tape system currently existing and which is obtained by combining the areal density of a pre-formatted optical disc media with the large storage surface area of a linear tape media.

These and other objects and features of this disclosure will be more clearly apparent from the following description when taken in conjunction with the accompanying drawings, briefly described below.

### BRIEF DESCRIPTION OF THE DRAWINGS

FIG. 1 is a side elevation view of an exemplary embodiment of an apparatus and a method according to the present disclosure for embossing, or pre-formatting, information-bearing structures in a linear optical data storage media;

FIG. 2 is a side elevation view of an exemplary embodiment of an apparatus and a method according to the present disclosure for applying recordable layers over the embossed information-bearing structures of the linear optical data storage media of FIG. 1;

FIG. 3 is a top plan view of a head-media area of an exemplary embodiment of an optical information storage system constructed in accordance with the present disclosure and including multiple optical heads and the pre-formatted linear optical data storage media of FIG. 1;

FIG. 4 is an enlarged, perspective view, partially in section, of the pre-formatted linear optical data storage media and some of the optical heads of the system of FIG. 3;

FIG. 5 is a perspective view of the optical information storage system of FIG. 3, and further shows a block diagram of a controller arrangement of the system;

FIG. 6 is an enlarged, cut-away view of an exemplary embodiment of a pre-formatted disc substrate according to the prior art;

FIG. 7 is a plan view of the disc substrate of FIG. 6; and

FIG. 8 is an enlarged, cut-away view of another exemplary embodiment of a pre-formatted disc substrate according to the prior art.

Like reference characters designate identical or corresponding components and units throughout the several views.

### DETAILED DESCRIPTION OF AN EXEMPLARY EMBODIMENT OF THE DISCLOSURE

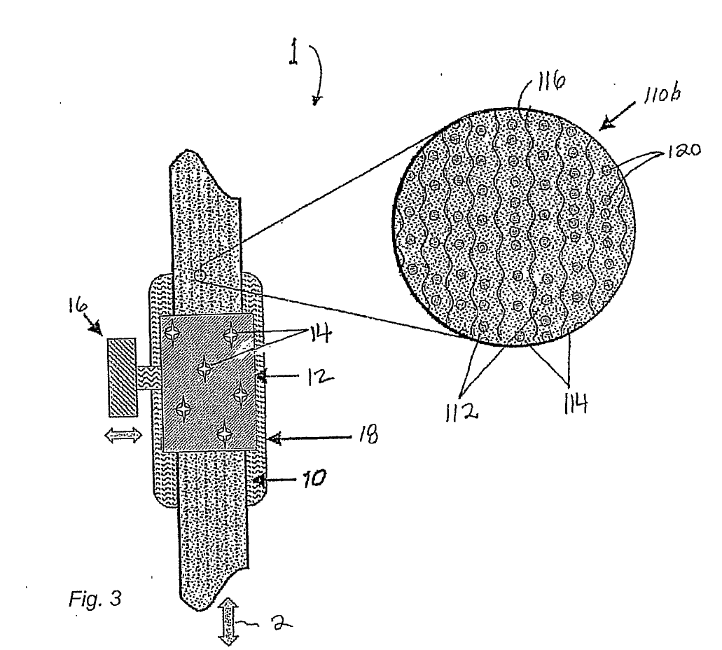

Referring first to FIGS. 3-5, there is shown an exemplary embodiment of an optical information storage system 1 including a pre-formatted linear optical storage media, or pre-formatted optical data storage tape 10, constructed in accordance with the present disclosure. In particular, the pre-formatted optical data storage tape 10 comprises linear optical data storage media having pre-embossed information-bearing structures. The pre-formatted optical storage tape 10 of the present disclosure enables significant improvements relative to existing storage systems in terms of areal density, storage capacity, performance, and cost. The improved performance of the system described herein includes, but is not limited to, high storage capacity, improved media-drive interchange characteristics, fast data access times, high read/write rates, and archival media. Of particular significance is the benefit of a total storage capacity that is several orders of magnitude greater than any optical disc or magnetic tape system currently existing and which is obtained by combining the areal density of a pre-formatted optical disc media with the large storage surface area of a linear tape media.

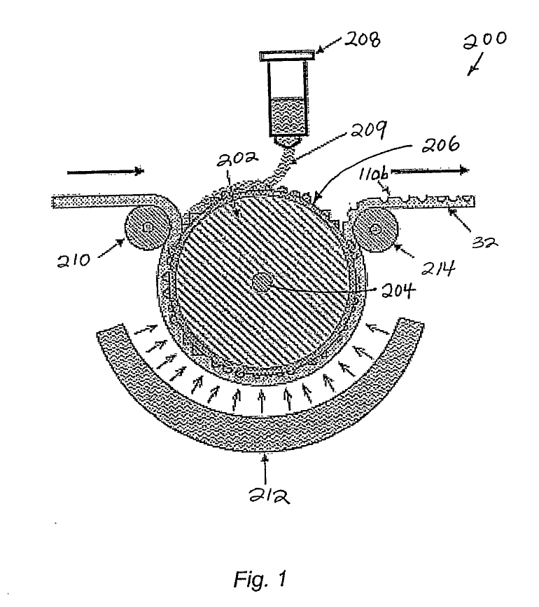

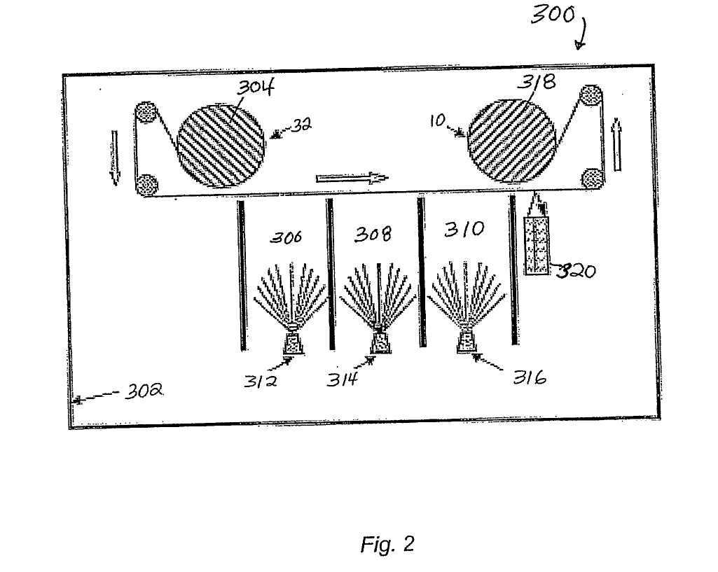

FIGS. 1 and 2 show exemplary embodiments of apparatuses and methods according to the present disclosure for manufacturing the pre-formatted optical data storage tape 10 shown in FIGS. 3-5. The apparatuses and methods of the present disclosure will be described in detail below, but first the optical information storage system 1 and the pre-formatted optical storage tape 10 are described.

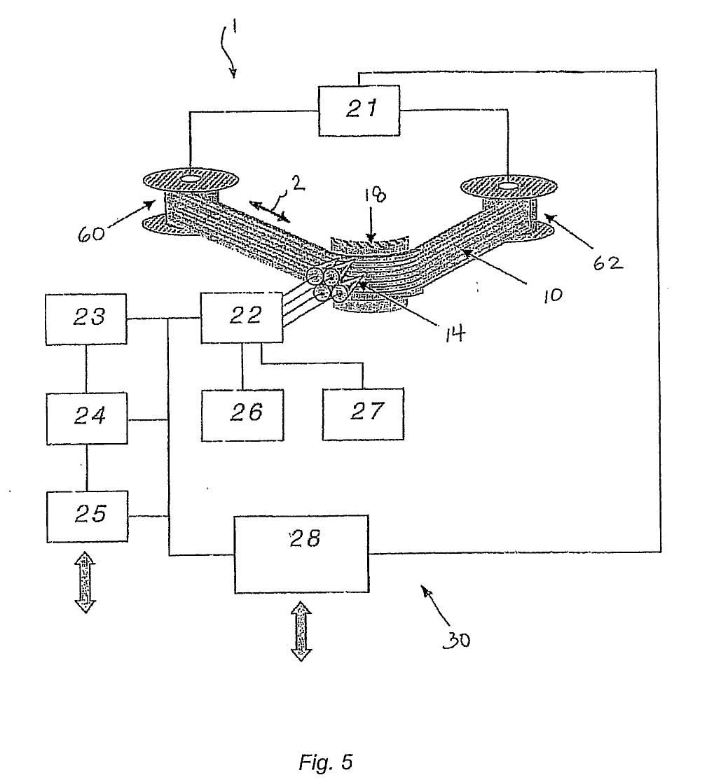

As shown best in FIG. 5, the optical information storage system 1 includes an optical head array 12 for reading the pre-formatted optical storage tape 10, a spool system 60, 62 for containing the pre-formatted optical data storage tape 10 and for moving the tape 10 with respect to the optical head array 12, and a control system 30. The tape 10 is moved bi-directionally, as shown by arrow 2, with respect to the optical head array 12 by the spool system 60, 62. Referring to FIG. 3, the optical head array 12 includes independent optical head pickup units 14 (not drawn to actual scale), such as those typically used in CD and DVD drives, and the like, and is positioned over the tape 10. The tape 10, in turn, is supported by an air-bearing surface or backing plate 18, which supports and stabilizes the lateral and out-of-plane motion of the tape 10. The lateral movement (generally perpendicular to the tape direction) of the optical head array 12 is controlled by an actuator 16, as shown in FIG. 3. Focus and tracking is independently provided by each head pickup unit 14 and related control electronics and circuitry.

A simplified general block diagram of one exemplary embodiment of an overall system 1 of this disclosure is shown in FIG. 5. As shown, the pre-formatted optical tape 10 is transported bi-directionally over the tape backing support 18 by the synchronized action of the spools 60, 62, whose motors (not shown) are controlled by a controller unit 21. The array of optical head pickup units 14 (four shown for simplicity in this view) reads from and writes to individual preformatted tracks of the tape 10, as controlled by an optical head controller block 22. Each individual optical pickup unit 14 has a servo focus actuator 26 and tracking servo actuator 27 (typically incorporated into the head unit). System input/output is provided through interface block 25, which may utilize any of a number of high-speed standard interface protocols, such as fiber-channel, SCSI, or firewire. The system controller 28 provides the user interface as well as overall system task management. Other functions, such as compression/decompression and error correction are handled by the respective processing unit(s) 23, 24. It is clear from this example that any number of hardware configurations is possible in order to create a system based on the combination of optical pickups 14 and pre-formatted linear information medium 10 as provided by the present disclosure.

The pre-formatted optical data storage tape 10 is characterized by a thin (in the approximate range of 4 microns to 1000 micron), elongated tape-like substrate having a plurality of physical structures on at least one surface in order to provide position, tracking, or pre-recorded information to an optical head or pickup unit, and which substrate can also contain additional layers to facilitate reading or writing of user data on one or both surfaces. The recording layer(s) belong to a class or classes of materials known to the art that changes one or more physical properties in response to exposure to laser or other actinic radiation, including particularly such radiation as would be emitted from an optical disc head. The aforementioned class of materials includes phase change and dye-polymer media. The pre-formatted optical data storage tape 10 of the present disclosure can be provided on open reels, cartridges, or cassettes having a single hub or dual hubs, or any of a number of configurations for storage, transport, and handling of the media.

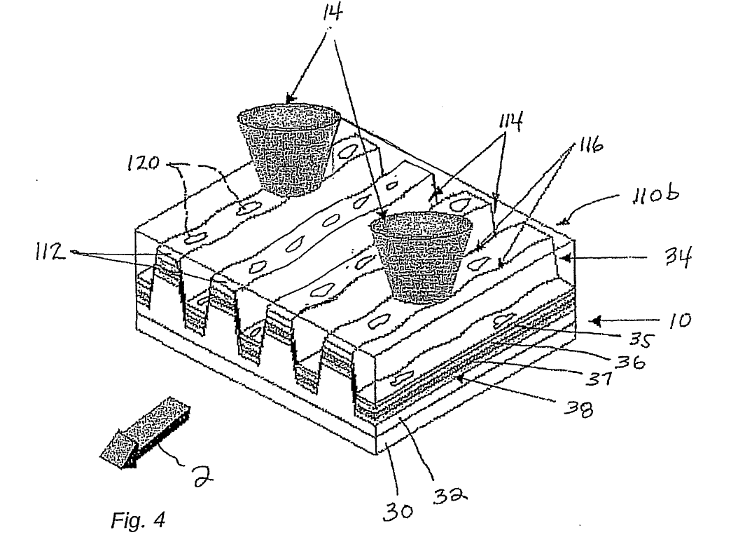

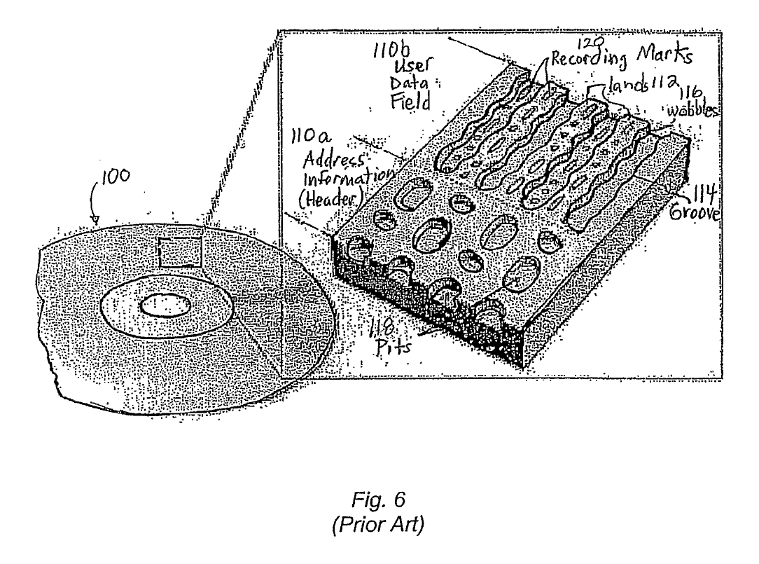

Enlarged views of the tape 10 substrate with pre-format structure and user data is shown in FIGS. 3 and 4. The pre-format structure of the optical tape 10 can, for example, be similar to optical disc pre-format structures presently available in CDs and DVDs, examples of which are shown in FIGS. 6-8. It may be appreciated that, generally speaking, the optical disc head pickup units 14 do not recognize the patterns tracked as being circular or linear, since the radius of curvature of the disc track is very large compared to the width of the track. For all intents and purposes optical disc head pickup units, such as shown in 14, “see” patterns of optically readable embossments. Thus, the optical head pickup units 14 normally used with discs can be used with the linear optical tape 10 with only some modifications. Such modifications may include the use of an optical compensator (e.g., a piece of glass or plastic) to correct the optical beam path for the “missing” disc substrate (typically 0.6 mm thick polycarbonate for DVDs), which can be bonded to the lens or interposed between the beam and substrate, for example.

As shown in FIGS. 3 and 4, the optical head pickup units 14 read formatted tracks comprising user data field 110b on the surface of the tape 10, and also read recording marks 120 on the formatted tracks. The optical head pickup units 14 also can be used to write recording marks 120 in the recording layers over the formatted tracks. In the exemplary embodiment shown, the formatted tracks of the user data field 110b can exhibit a great degree of complexity, including lands 112 and grooves 114, wherein side walls 116 of the grooves 114 are wobbled for tracking purposes, all contributing to the ability of such formatted media to achieve very high storage densities. Such features are created by use of molding processes generally known to the art. These or other features are similarly used in pre-formatted CD and DVD media, to enable recording of marks 120 by the user using the “off-the-shelf” CD or DVD-type opto-electronics units. In the exemplary embodiment shown in FIGS. 3 and 4, the recording marks 120 are placed on both the lands 112 and in the grooves 114. It should be noted that, in addition to pre-format structures similar to those used in CD/DVD discs, other pre-format structures and schemes can also be used.

Various coatings are placed over the pre-formatted optical data storage tape 10 and may include layers with reflective, dye polymer, WORM, erasable, protection or the like functionality. In the exemplary embodiment shown in FIG. 4, the tape 10 includes a carrier layer 30 (such as polyethylene terephthalate, PET, polyethylene naphthalate, PEN, or other) which is selected for physical strength and durability, and a polymer layer 34 (such as polycarbonate, acrylic, cellulose acetate butyrate or the like), which is selected for replication of the formatted tracks with high resolution.

Several layers of thin-film coatings comprise a phase change stack, and include the following layers for example, in order from the read/write incident surface, there first being a protective overcoat layer 34 (polymeric or inorganic), an outer dielectric layer 35, a phase change recording layer 36 (typically a Te alloy), another dielectric layer 37, and a reflection/thermal control/nucleation layer 38. The aforementioned individual layers of such a phase change stack are known to the art as might general constitute rewritable layers as used in existing CDs and DVDs. It should be noted, however, that an embodiment of the pre-formatted optical data storage tape 10 of this disclosure in which the tape is read from the “first surface” (radiation incident on the features-containing surface of the tape), the order, thickness and composition of said layers is different from those used in existing optical discs, wherein in existing optical discs such layers are designed to operate as second-surface (substrate-incident) devices. It should also be noted that the layers of the pre-formatted optical data storage tape 10 can be varied in number, composition, thickness, etc. to operate in a write once or erasable mode. These layers can also be contrived to have either write-once (i.e., cannot be altered after user data is written) or erasable (user can erase and re-use media) characteristics. In another embodiment of the tape medium, a dye-based recording means, such as is known to the art in regard to so-called “write-once” CDs and DVDs, is used in place of the phase-change layers. In the case of “second surface” recording, (i.e., reading/writing through the substrate before encountering the recording layers, the order, the thicknesses, and the composition is adjusted accordingly.

The pre-formatted optical data storage tape 10 can also include one or more back coat layers on the side opposite the format side. The back coat layers may include single or multiple layers for providing friction and/or surface control, thermal conductivity, and/or dissipation of static electricity. It should also be noted that the thermal, electrical, and friction control that is afforded by single or multiple applied back coat layers can also be accomplished by incorporation of polymeric or inorganic materials into the carrier layer 30, or co-extruded during the manufacturing process thereof.

The pre-formatted optical data storage tape 10 can include format structures and features readable by DVD-type optical head(s), such as DVD-RW, DVD-R, DVD+RW, DVD+R, DVD-RAM as well as other format types. Such optical heads may include modifications to accommodate adjustments necessary for conversion from rotational to a linear format and for changes in optical path length cause by, for example, differences in the overcoat or cover sheet thickness overlaying the optically sensitive surface as compared to the standard optical disc media, as previously mentioned. The pre-formatted structures can also can include formats such as are characteristic of CD, magneto-optical disc, and similar discs. The pre-format pattern can include any of a number of general format configurations, including continuous groove, land and groove, sampled servo, wobble groove, distributed digital servo (as disclosed in U.S. Pat. No. 5,452,285), or the like. Pre-format features typically include track structures, header information, servo and error correction information, and may also include pre-recorded digital and/or analog information.

The layer(s) that are applied to the formatted tape 10 may include one or more of the following functionalities: write-once (WORM), erasable, PROM (read-only and recordable combined), or read-only (ROM). The recordable and/or erasable layers can be based on phase change (as disclosed in U.S. Pat. Nos. 4,981,772 and 5,077,181), dye-polymer (as disclosed in U.S. Pat. No. 5,382,463), or any such layer or layers that are sensitive to the radiation of the appropriate optical head. The layers for ROM functionality can be comprised of aluminum or gold or other materials of appropriate reflectivity.

The pre-format structures of the optical data storage tape 10 can include a wide variety of features, including lands, grooves, pits, data and ROM information, etc. Such features can be either recessed or proud relative to the plane of the substrate, and can be in the nanometer regime of critical dimensions. In addition, both sides of the pre-formatted optical data storage tape 10 can be utilized, such as having a recordable or ROM layer on either or both sides or layers with different functionalities (WORM, erasable, ROM) on different sides.

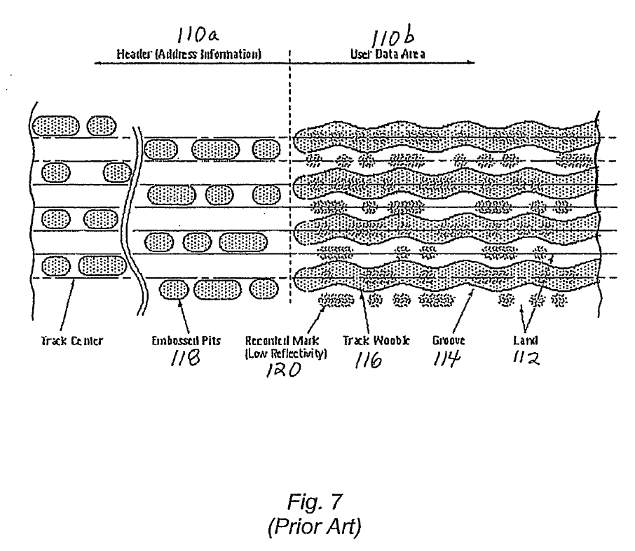

Now referring to FIGS. 6 and 7, an enlarged, cut-away view of an exemplary embodiment of a pre-formatted optical disc (e.g., a DVD or CD) substrate 100 according to the prior art is shown and includes pre-formatted surface patterns 110a, 110b. These types of pre-formatted surface patterns 110a, 110b and the appropriate optical disc head and electronics, when used together, form the basis of optical disc data storage systems currently used for data and/or video storage, and the like. According to the present disclosure, pre-formatted surface patterns that are similar to the pre-formatted surface patterns 110a, 110b of the prior art and the appropriate optical disc head and electronics of the prior art are used with the pre-formatted optical data storage tape 10 of the present disclosure, as shown for example in FIGS. 3-5. Appropriate modifications can be made to account for the differences in disc media and linear media as seen by an optical head, including compensation for differences in optical path length caused by the thinner cover layer in the linear media relative to the disc media. Such modifications may include, for example, placing a small piece of material, such as polycarbonate, in the optical path of the lens in order to provide the requisite 0.6 mm optical path length, in the case of the DVD, for which the pickup optics were originally designed. Changes in detection signal polarity (for write bright versus write dark recording schemes) or tracking/servo electronics (to compensate for format changes necessitated by the pattern of optically readable embossments structure) may also be applied to such “off-the-shelf” opto-electronics units.

It can be seen from the exemplary embodiment shown in FIGS. 6 and 7 that the pre-formatted surface patterns 110a, 110b of the disc 100 can exhibit a great degree of complexity, including lands 112, grooves 114, wobble grooves 116, pits 118, and various fine structures, all contributing to the ability of such formatted media to achieve very high storage densities. Such features are not readily created by use of high-throughput post-manufacturing formatting (sometimes referred to as “servo-writing”) processes. One of the pre-formatted surface patterns 110a comprises an address information header, which is used by “off-the-shelf” opto-electronics units to determine the position on the recording media, while the other pre-formatted surface pattern 110b comprises a user data field, upon which recording marks 120 can be created by “off-the-shelf” opto-electronics units.

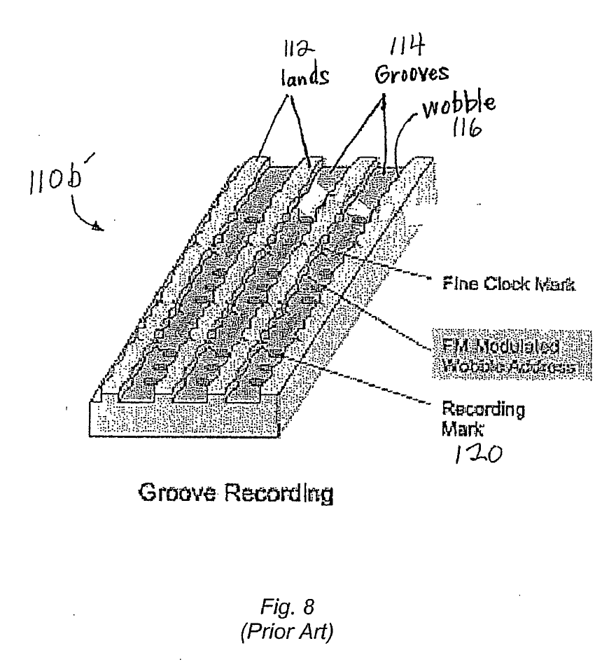

In the exemplary embodiment shown in FIGS. 6 and 7, the recording marks 120 are placed on both the lands 112 and in the grooves 114. FIG. 8 shows another exemplary embodiment of a pre-formatted disc substrate 100 according to the prior art, and including a pre-formatted surface pattern 110b′ comprising a user data field. The pre-formatted surface pattern 110b′ of FIG. 8 is similar to the pre-formatted surface pattern 110b of FIGS. 6 and 7 such that similar elements have the same reference numerals. In the pre-formatted surface pattern 110b′ of FIG. 8, however, the recording marks 120 are placed just in the grooves and not on both the lands 112 and the grooves 114. The pre-formatted surface pattern 110b′ of FIG. 8 can also be applied to the linear optical media of the present disclosure, as shown for example in FIGS. 3-5. It should also be appreciated that other formats, with or without lands and grooves, can also be used for guiding, tracking, and recording user data and information.

In order to describe the benefits of pre-formatting linear storage media, a comparison can be made to a typical common optical disc type, the DVD. The useable area of a typical 120 mm diameter optical disc (93 cm²) is equivalent to about ¾ m of a standard (12.5 mm) width tape. Thus, by incorporating a DVD-like format (and using appropriate optical heads, etc.) into the tape medium of this disclosure, the total storage capacity of a single cartridge containing 1,000 m of standard ½-inch tape, for example, would be 6,300 GB (6.3 terabytes, or TB). For comparison, a single surface of a typical DVD holds 4.7 GB of information. The use of blue lasers or other modifications under development by DVD manufacturers can further increase this capacity by a factor of 6.

The use of a format containing DVD-like format features enables reading and writing of the pre-formatted optical data storage tape 10 with DVD heads, having electrical and/or optical modifications as necessary to accommodate modifications or improvements of the embedded format. Due to the linear nature of these features, the use of multiple optical heads or groups of heads is also disclosed. Each head can utilize its intrinsic focus and tracking capabilities independently in order to accommodate any track-to-track variation, etc. The multiplicity of optical heads can be arranged in a manner so as to maximize the number of heads in order to achieve a maximum data rate. It may be appreciated that use of smaller optical head assemblies will enable more heads and a higher data rate. Furthermore, the optical heads can be arranged within a head assembly fixture 12 such that each head can read and/or write a number of tracks without requiring the fixture to move. Alternatively, the fixture can be designed to move in a direction generally across the tape in order to enable the heads to access a larger range of tracks (particularly if a single head is used). The use of existing electro-optic components, such as optical disc heads incorporating auto focus, servo tracking, etc., greatly reduces the cost of the read-write head(s) in the companion drive hardware for this tape format, especially if multiple heads are used.

FIG. 1 is a side elevation view of an exemplary embodiment of an apparatus 200 and a method according to the present disclosure for embossing, or pre-formatting, information-bearing structures in a linear optical data storage media, such as the pre-formatted optical data storage tape 10 shown in FIGS. 3-5. An unwind spool (not shown) feeds the smooth polymeric substrate 32 tape 10 into a pre-format forming zone, whereupon the substrate 32 is placed in contact with a rotary tool, or drum 202. The drum 202 is mounted for rotation about an axle, or rotation axis 204, and has an outer circumferential outer surface 206 having a predetermined pattern of protrusions for embossing at least one pre-formatted pattern of optically readable embossments 110b in the surface of the substrate 32 as the substrate is rolled over the drum 202. In one embodiment, a softening chemical 209 is applied to the surface 206 of the drum 202 using a dispenser 208, such that the rotation of the drum brings the softening chemical into contact with the substrate 32 as the substrate is rolled onto the drum. The substrate, or another polymer layer on the substrate, is chosen so as to be softenable by contact with the dispensed agent. A semi-solid surface layer forms on the substrate 32 from contact with the softening chemical, and the amount of the softening chemical that imbibes into the substrate 32 is controlled by metering action and pressure exerted by an elastomeric backing roll 210, which is engaged against the back side of the substrate 32.

In order to accurately reproduce the features of the format pattern 110b, it is necessary to re-solidify the softened layer of the substrate 32 while the substrate 32 is still in contact with the surface 206 of the drum 202, otherwise the features will be distorted due to material flow after separation from the drum. Thermal radiation (illustrated in the drawings with arrows) may optionally be supplied by a heating source 212 to re-solidify the surface by accelerating the rate of diffusion of the chemical away from the layer in direct contact with the format drum 202, resulting in rapid re-solidification prior to removal from the drum. Separation of the now-patterned substrate 32 from the drum surface 206 is facilitated by a second backing roll 214, and then the pre-formatted substrate 32 is wound onto a take-up spool (not shown). It is an important feature of this embodiment that rapid re-solidification of the substrate or polymer layer 32 enables high manufacturing process speeds.

In another exemplary embodiment of the process, the softening chemical can be replaced with a liquid polymeric material that can be hardened by radiation, such as is known to the art, where the radiation source is of an appropriate wavelength (e.g., ultraviolet) to cause the polymer to become solid prior to separation from the drum 202. Use of such a liquid polymer has the additional benefit of simultaneously filling and planarizing the substrate during the time that the substrate, polymeric material, and tool are in contact. This can, among other things, compensate for scratches and non-uniform substrate surface features. A liquid polymer also offers the advantage that the physical and chemical properties of the substrate and polymer material can be chosen with some degree of independence, which allows each component (the substrate and the polymer layer) to be optimized according to the requirements of each (for example, optimizing the substrate for physical strength and tear resistance, and optimizing the polymer layer for ability to replicate fine surface details). The radiation source may be placed inside the drum 202 and the drum made of suitable radiation transparent material.

It is an aspect of this disclosure that any of the above-described pre-formatting processes, when used with a precision continuous and seamless pre-formatting tool 202 having essentially pre-patterned format features on a surface 206 thereof, and subsequent coating of a recordable layer, can produce a pre-formatted linear information-carrying and/or recording medium 10 of any arbitrary length or width.

It is also an aspect of this disclosure that the pre-formatted linear substrate 32 may be coated with a layer or layers that enable the recording of information on the substrate 32. This includes, but is not limited to, write-once (WORM), erasable, dye-polymer, and the like, or any combinations thereof. The recordable and/or erasable layers can be based on phase change (such as those disclosed in U.S. Pat. Nos. 4,981,772 and 5,077,181), dye-polymer (such as disclosed in U.S. Pat. No. 5,382,463), or any such layer or layers that are sensitive to the radiation of the appropriate optical head.

Other embodiments of the linear storage means of this disclosure may incorporate other recording and information encoding schemes as are known to the art, including but not limited to grayscale (multi-level), nearfield, fluorescent, volumetric, holographic, or any other such means (e.g., ISOM/ODS Conference on Optical Data Storage, July 2002, HI).

It is also a useful feature of this disclosure that the recordable layer can be embedded into the polymer layer simultaneous with the creation of the format features, thus eliminating an additional process step. This is accomplished by dissolving a dye, such as is known to the art of CD-R or DVD-R manufacturing, into the polymer-softening chemical, where the dye and chemical are chosen for chemical compatibility. The short imbibition time of the dye into the polymer resulting from the high-speed contact of substrate and tool causes the dye to precisely and closely follow the profile of the format features, such that radiation from a laser source, for example, is highly concentrated at the surface of the polymer and can be thereby marked by action of the impinging radiation. The effect can be amplified by application of a reflective coating such that the dye layer is addressed and reflected radiation detected from the second (substrate) side.

FIG. 2 is a side elevation view of an exemplary embodiment of an apparatus 300 and a method according to the present disclosure for applying recordable phase change layers over the embossed information-bearing structures 32 of the linear optical data storage media 10 of FIG. 1. The exemplary embodiment shown provides up to a three layer deposition process, which might be used, for example, for a write-once phase change formulation. However, additional layers can be applied, the number and composition being dependent on the specific functionality desired (e.g., write-once, erasable, or ROM functionality).

It is important to note that standard recipes in the prior art for such layers, particularly of the Ge—Sb—Te phase change type, are designed for optical disc applications, utilizing second surface (substrate-incident) recording. Such a second-surface sensitive layer structure, however, will not work for first surface (“format-incident”) media and must be substantially modified for use in first-surface media such as the present disclosure. For example, the layer structures appropriate for the media of this disclosure in a phase change WORM (write-once) embodiment require that the reflector (or nucleating) layer be deposited first, directly on the formatted surface of the substrate, followed by the phase change alloy layer, and followed in turn by a protective layers (or layers). Furthermore, the layer thickness and composition need to be optimized for first-surface recording, including such factors as layer thickness, thermal conductivity, and refractive indices.

The device 300 for applying the phase change layers to the formatted substrate includes a vacuum chamber 302, an unwind spool 304 which supplies formatted substrate 32 to the vacuum coating zones 306, 308, 310 containing a multiplicity of independent deposition sources 312, 314, 316, the number and composition being dependent on the specific functionality desired (write-once, erasable, ROM), and a rewind spool 318 receiving the finished tape 10. As previously mentioned, the last layer as seen by the incident light beam (typically a refection/thermal control layer in a write-once embodiment) is applied first. The second layer, which is the phase changer alloy, is deposited in the next zone, followed by the third (protective) layer in zone. It should be noted that as few as one layer or as many as five or more layers may be required for the phase change recordable layer. Also, additional layers may be added, either by vacuum or other process, such as solution coating, to either or both surfaces. The apparatus may also include an optical head 320 for applying recording marks to the write-once layer.

In another embodiment, an embossed substrate 32, after deposition of the light-sensitive layer(s), has a protective coat applied over the last layer. This can be done in the vacuum chamber 302, where the protective coat is an inorganic material or blend of materials. Additionally, this can be done by applying a cross-linkable photopolymer material to the deposited layers, and exposing the cross-linkable photopolymer material to a source of radiation, such as an ultraviolet light source or an electron beam source, that is capable of activating cross-linking of the polymeric material. Such layers and processes are known to the art.

In a related embodiment, the thickness and smoothness of the applied polymeric overcoat layer can be suitably modified by laminating the over-coated substrate, while still in the liquid state, against a suitably transparent surface, such as in the form of a roll or platen, while under suitable pressure, and effecting the cross-linking process by exposure of the laminate to radiation through the transparent surface. The surface texture of the roll or platen can be such that, upon cross-linking and subsequent separation, the outer surface of the media of this disclosure has a replica of the desired surface texture. This is useful for light control and/or friction control, among other things. If the overcoat is electrically conductive, such as by the use of a conductive inorganic or polymeric material, then such a coated surface can also provide static electricity dissipation.

It is an aspect of this disclosure that the pre-formatting and subsequent coating operations can be done on a substrate whose width is that of the desired product, such as ½ inch or 35 mm, etc. In a slitting operation the substrate is provided in wide widths, such as from several inches to several meters in width, and after the coating step, cut into narrower widths. In an embodiment of the slitting operation, the pre-format pattern may be used with an optical pickup unit to track the material during the slitting operation and to use the electronic signal so generated to provide feedback to a web guide or the like on the slitting machine to allow precise division of the master substrate roll. This is useful when it is necessary or useful that slit edge be registered with a particular section of the master pattern, such as for example where the outer portion of each finished tape correspond to a particular edge guide section of the pattern.

It should be understood that the embodiments of the present disclosure described herein are merely exemplary and that a person skilled in the art may make variations and modifications to the embodiments described herein without departing from the spirit and scope of the present disclosure. All such equivalent variations and modifications are intended to be included within the scope of this disclosure as defined by the appended claims. None of the present disclosure is meant to be disclaimed.

What is claimed is:

1. An apparatus for manufacturing pre-formatted linear optical data storage media including an elongated linear polymer layer, comprising:
a drum mounted for rotation about a rotation axis, and including a circumferential outer surface having a predetermined pattern of protrusions for embossing at least one pattern of optically readable embossments in an elongated linear polymer layer rolled on the drum; and
a radiation source for causing the pattern of optically readable embossments of the elongated linear polymer layer to solidify prior to the embossments being removed from the protrusions of the outer surface of the drum.

2. An apparatus according to claim 1, further comprising a dispenser for dispensing a liquid between the outer surface of the drum and an elongated linear polymer layer rolled on the drum.

3. An apparatus according to claim 2, wherein the dispenser contains a chemical for softening the surface of the polymer layer, and wherein the radiation source provides heat for causing the pattern of optically readable embossments of the elongated linear polymer layer to solidify.

4. An apparatus according to claim 2, wherein the dispenser contains a liquid polymeric material that can be hardened by radiation of a predetermined wavelength, and wherein the embossments are made in the liquid polymeric material and the radiation source provides radiation of the predetermined wavelength.

5. An apparatus according to claim 1, further comprising backing rollers pressing the elongated linear polymer layer against the drum.

6. An apparatus according to claim 1, further comprising a vacuum chamber containing deposition sources for applying an optical recording layer covering the pattern of optically readable embossments of the elongated linear polymer layer, and wherein the vacuum chamber is adapted to receive the embossed elongated linear polymer layer.

7. An apparatus according to claim 1, further comprising deposition sources for applying an optical recording layer over the pattern of optically readable embossments of the elongated linear polymer layer.

8. An apparatus according to claim 7, further comprising an optical head array adapted to write recording marks in the optical recording layer over the pattern of optically readable embossments.

9. An apparatus according to claim 1, wherein the protrusions of the drum comprise ridges and bosses.

10. An apparatus according to claim 1, wherein the protrusions of the drum form a pattern of optically readable embossments providing header information, servo and error correction information, pre-recorded digital information, and pre-recorded analog information.

11. A method for manufacturing pre-formatted linear optical data storage media including an elongated linear polymer layer, comprising:
softening a surface of an elongated linear polymer layer;
embossing at least one pattern of optically readable embossments in the softened surface of the elongated linear polymer layer using a drum having protrusions; and
hardening the embossed surface of the elongated linear polymer layer prior to removing the linear polymer layer from the drum.

12. A method according to claim 11, further comprising dispensing a softening agent onto the surface of the polymer layer to soften the surface prior to embossment, and then hardening the embossed surface by heating.

13. A method according to claim 11, wherein a liquid polymeric material that can be hardened by radiation is applied to the surface of the polymer layer, and wherein the embossments are made in the liquid polymeric material, and then radiation of an appropriate wavelength is applied the liquid polymeric material after embossing to cause the liquid polymeric material to become solid.

14. A method according to claim 11, further comprising applying an optical recording layer over the pattern of optically readable embossments of the elongated linear polymer layer.

15. A method according to claim 14, further comprising forming recording marks in the optical recording layer.

16. A method according to claim 14, wherein the optical recording layer comprises a dielectric layer, a phase change recording layer, and a reflection/thermal control/nucleation layer.

17. A method according to claim 11, wherein the pattern of optically readable embossments comprise lands and grooves, and wherein side walls of the grooves are wobbled for tracking purposes.

18. A method according to claim 11, wherein the optically readable embossments provide header information, servo and error correction information, pre-recorded digital information, and pre-recorded analog information.

19. A method according to claim 11, wherein a recordable layer is embedded into the polymer layer simultaneous with the embossment.

20. An apparatus according to claim 2, wherein the dispenser contains a dye for embedding a recordable layer into the polymer layer simultaneous with the embossing.
